(19) United States
(12) Patent Application Publication
(10) Pub. No.: US 2003/0230535 A1
(43) Pub. Date: Dec. 18, 2003

(54) Downhole desalination of aquifer water

(76) Inventors: Christian Jeremy Affeld, Rijswijk (NL); Ronald Anton Hofland, Rijswijk (NL); Zara Ibrahim Khatib, Bellaire, TX (US); Paulus Henricus Joannes Verbeek, Rijswijk (NL); Chad Alan Wittfeld, Rijswijk (NL)

Correspondence Address: Del S. Christensen, Shell Oil Company, Intellectual Property Services, P. O. Box 2463, Houston, TX, 77252-2463, US

(21) Appl. No.: 10/452,531

(22) Filed: Jun. 2, 2003

(30) Foreign Application Priority Data
Jun. 3, 2002 (EP) 02077176.2

(51) Int. Cl. B01D 61/02

(52) U.S. Cl. 210/652; 210/650

(57) ABSTRACT

A method and well is disclosed for desalinating saline aquifer water, wherein saline aquifer water flows from a subsurface aquifer layer directly into a downhole aquifer inflow region of a desalinated water production well in which a downhole assembly of one or more desalination and/or purification membranes is arranged, which separate the saline aquifer water into a primary desalinated water stream which is produced through the well to surface and a secondary concentrated brine reject stream, which can be disposed into a subsurface brine disposal zone.

### BACKGROUND OF THE INVENTION

The invention relates to a process for desalinating and purifying saline water received from a downhole aquifer.

In many remote locations water is produced from a permeable subsurface zone (a so-called aquifer or aquifer layer) to surface through a well. However, the water is often saline and therefore requires desalination and possibly further purification in order to obtain a useful water quality, in particular potable water. Saline water is sometimes also referred to as brackish water.

In a known method to desalinate saline aquifer water that is received at surface from an aquifer layer through a well, the water is transported via a pipeline to a membrane separation unit at some distance from the wellhead.

A major disadvantage of existing, membrane-based desalination techniques for saline aquifer waters is that the feed water is often very clean at source (except for its salinity), but becomes contaminated with solids and/or bacteria/algae in the production/transportation system.

In addition, temperature and pressure changes may give rise to the precipitation of mineral particles (‘scaling’) upstream of the membrane separation unit. Corrosion of steel system components will generate solid corrosion products, and bacteria if not treated may colonize the upstream system and cause bio-fouling, such as formation of a so-called biofilm. When left un-addressed, all these phenomena result in rapid membrane fouling, and a sharp drop in performance, to the point that membranes need to be exchanged frequently.

A comprehensive, effective chemical treatment system is required in existing installations to negate this effect, which places an appreciable burden on operators and logistics, and incurs excessive extra cost, which can amount to as much as 70% of the total operating cost. Bio-fouling, for example, is combated by injecting chemicals into the flowline, so-called biocides.

### SUMMARY OF THE INVENTION

In accordance with the invention saline water, as present in a permeable subsurface zone (aquifer), is induced to flow from the subsurface aquifer layer into a well, either by a natural pressure gradient between the aquifer and the well, or supported by a downhole pump.

The water is then routed through an assembly of one or more membranes, which preferably is installed in the well's production tubing in such a way that it can easily be retrieved.

The desalinated water emanating from the membrane's product (permeate) side will be produced to surface, either by natural forces or by pump assistance. Suitably, the water is desalinated and if necessary purified to a degree that it can be used as drinking water (fresh water).

Thus, saline aquifer water flows from a subsurface aquifer layer into an inflow region of a well in which a downhole assembly of one or more desalination and/or purification membranes is arranged which separates the saline aquifer water into a primary desalinated water stream which is produced through the well to surface and a secondary concentrated brine reject stream.

Preferably, the secondary brine reject stream is injected into a subsurface disposal zone. The disposal zone is suitably formed by a permeable earth formation layer which is at least partly hydraulically isolated from the source aquifer layer.

Suitably, the downhole membrane assembly comprises one or more reverse osmosis, nano-filtration, non-porous hydrophilic, semi-permeable and/or other water desalination and/or purification membranes, and the downhole membrane assembly suitably comprises a plurality of stacked substantially tubular membrane modules.

It is known from Perry's Chemical Engineers' Handbook, Sixth Edition, Robert Perry and Don Green p. 17-22 to 17-25 that a reverse osmosis separation process separates a solute from a solution by forcing the solvent to flow through a membrane by applying a pressure greater than the normal osmotic pressure. Four common membrane designs are spiral wound, hollow-fibre, tubular, plate-and-frame, and all of these designs can be used in a membrane assembly according to the invention.

It is also known to those skilled in the art that nano-filtration is a form of filtration that uses membranes to preferentially separate different fluids or ions. Nano-filtration is not as fine a filtration process as reverse osmosis, but on the other hand it does not require the same energy to perform the separation. Nano-filtration also uses a membrane that is partially permeable to perform the separation, but the membrane's pores are typically much larger than the membrane pores that are used in reverse osmosis. Reverse osmosis membranes can also be dense membranes without pores. Nano-filtration rejects a lot of the smaller organics that pass through other membranes such as ultrafiltration membranes and yet can pass more water at lower operation pressures than can reverse osmosis, resulting in a more energy/cost efficient procedure. It can remove particles in the 0.1-0.001 μm molecular size range (like humic acid and organic colour bodies present in water) and can reject selected (typically polyvalent) salts. A membrane that can be used for desalination can normally also remove further contaminants that may be present in the water to be treated, such as bacteria, and therefore by desalination often also some degree of further cleaning/purification is achieved. The opposite is not always true, i.e. not all membranes that can be used for water cleaning also result in desalination. Hydrophilic membranes are membranes having an affinity for water, that are solid in structure yet allowing water molecules to pass through. Suitably these membranes are operated by heating the feed so that vapour is formed, water molecules of which vapour are allowed to diffuse through the membrane. Heating can for example be achieved by using solar energy. The passed through water molecules are then condensed on the permeate side of the membrane to collect the water. Hydrophilic membranes can produce highly desalinated water.

The downhole membrane separation assembly can in particular include a hybrid membrane assembly, which is an assembly including different types of membranes, in particular both a reverse osmosis as well as a nano-filtration membrane.

Preferably, the downhole membrane assembly is mounted downstream of a downhole pump, e.g. an electrical submersible pump (ESP) or a hydraulic pump, which pumps the primary desalinated (purified) water stream to surface, such that the pump provides both inflow and production/disposal energy to the membrane assembly. The electrical submersible pump and membrane assembly may be built together into a single unit, which is retrievable from, and insertable into, a downhole receptor near the inflow region of the well, using a conventional wireline hoisting system.

Various operating parameters, such as the composition and/or flowrate of the inflowing aquifer water and/or of the primary desalinated water stream produced to surface, pressures and temperatures at different points downhole, flow rate to surface, may be monitored with downhole monitoring devices, and the data are transmitted to surface via communication links such as an electric or fibre optical cable and/or wireless electromagnetic or acoustic telemetry systems.

Preferably, the reject water stream (retentate), which is a concentrated brine, also normally containing impurities and contaminants, is not produced to surface, but injected into a subsurface brine disposal zone. This is usually a deeper permeable layer, which has no or only limited fluid connection to the original source aquifer, i.e. which is at least partly hydraulically isolated from the source aquifer layer. In view of the volumes concerned, disposal will almost certainly require pump assistance.

It is, however, also possible to transport the concentrated brine retentate to surface, in particular when there is no disposal zone available. The retentate can then e.g. be used as so-called completion brine or workover brine, or for the production of drilling mud.

In accordance with the present invention there is also provided a well for producing desalinated water from a subsurface aquifer layer to surface, which well comprises a downhole aquifer inflow region and a downhole assembly of one or more desalination and/or purification membranes for separating the saline aquifer water into a primary desalinated water stream and a secondary concentrated brine reject stream, and a conduit for transporting desalinated fresh water to surface.

The invention also relates to membrane assemblies for use in a method or in a well of the invention, in particular membrane assemblies comprising a plurality of stacked membrane modules, and membrane assemblies built into a single unit with a downhole pump.

The main advantage of the invention is that it seeks to alleviate or eliminate the disadvantages of traditional desalination systems, as described above.

It offers greater simplicity and minimizes operator intervention, essentially by keeping the feed water clean rather than allowing it to become spoiled first in a potentially hot surface conduit (e.g. due to sunlight heating causing algae growth and biofilm formation), and subsequently trying to treat it back to near-original quality specifications (except for its salt content).

Another advantage is the reduction in infrastructure at surface or subsea, which contributes to elimination of the possibility of environmental incidents the surface and protects against vandalism.

A further advantage is that the bio-fouling is unlikely to happen downhole, so that injection with biocide chemicals is not or at least not as frequently needed as in known desalination methods. Suitably, the well is drilled and completed carefully so as to prevent bacteria/algae to grow downhole. Optionally, the well can be subjected to an initial treatment with biocides after completing the well and before starting up production.

The present invention relates to desalinating downhole aquifer water, which is different in several aspects from known methods for desalinating seawater. U.S. Pat. No. 3,283,813 discloses a downhole desalination process, wherein saline water, as present at surface, is being pumped into a subsurface earth formation, using an injection well. Fresh water percolating through the formation is pumped back to surface through a water production well, which is located at a suitable distance from the injection well. A reject stream of concentrated brine is disposed of in another subsurface layer, located beneath the osmotic earth layer and isolated from it by an impermeable subsurface barrier.

Furthermore, UK patent application GB 2068774 and U.S. Pat. Nos. 4,125,463; 5,366,635; 5,916,441 describe a process where seawater is pumped from top into a well fitted with a subsurface membrane, or a system where such a membrane is installed at seabottom. In either case, the membrane is installed at a certain depth so as to create a hydrostatic head that provides the energy for driving a reverse osmosis desalination unit.

U.S. Pat. No. 6,190,556 discloses a nano-filtration and reverse osmosis membrane desalination system for producing fresh water from seawater in a pressure vessel.

### BRIEF DESCRIPTION OF THE DRAWINGS

FIG. 1 is a schematic longitudinal sectional view of a wireline retrievable downhole pump and membrane assembly according to the invention.

FIG. 2 is a schematic longitudinal sectional view of a downhole pump and membrane assembly according to the invention which is connected to the lower end of a production tubing.

FIG. 3 is a schematic longitudinal sectional view of a downhole pump and membrane assembly according to the invention, wherein the pump is secured to the lower end of a production tubing and the membrane assembly is retrievable to surface through the interior of the production tubing.

FIG. 4 is a schematic longitudinal sectional view of a downhole pump and membrane assembly according to the invention, wherein the pump is secured at an inflow branch at the lower end of a production tubing and the membrane assembly is retrievable to surface through the interior of the production tubing.

### DESCRIPTION OF PREFERRED EMBODIMENTS

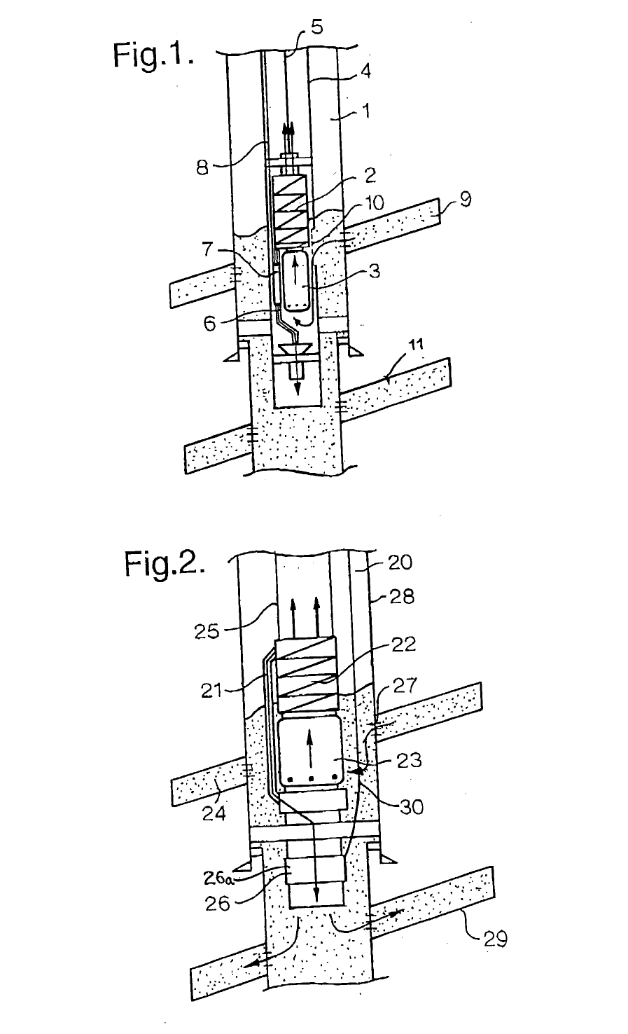

Referring to FIG. 1 there is shown a fresh water production well 1 comprising a downhole assembly of aquifer water desalination and/or purification membranes 2 which is built together with an Electrical Submersible Pump (ESP) 3 into a single wireline retrievable unit, which unit can be hoisted up and down through the purified water production tubing 4 by a wireline 5. Alternatively, the membrane assembly and pump are arranged so that they can be hoisted up separately. Also, the membrane assembly can be formed of stacked cylindrical or tubular membrane modules which can be hoisted up and down individually. A disposal bypass tube 6 extends from the lower end of the membrane assembly 2 alongside the ESP 3 into a brine disposal zone at the bottom of the well 1. A downhole flow and/or composition monitoring device 7 is connected by an electrical or fibre optical cable 8 to production monitoring equipment at the earth surface. Flow of saline aquifer water from an aquifer layer 9 will be taken into the tubing through a Sliding Side Door (SSD) 10 then drawn into the ESP 3. From there it will be fed into the desalination membrane assembly 2. Out of the desalination assembly 2, a secondary stream of concentrated brine will flow down the bypass tube 6 and into a saline reject water disposal zone 11 near the bottom of the well 1. The fresh water which passes through the semi-permeable wall of the desalination and/or purification membranes 2 flows up through the production tubing 4 to surface. The data recorded by the downhole monitoring device 7 are transferred to surface by the signal/power transmission cable 8 shown in the drawing or by a wireless data telemetry link.

The Electrical Submersible Pump 3 is shown mounted below the membrane assembly 2. The ESP 3 can also be mounted on top of the membrane assembly, but so that with respect to the water flow it remains upstream of the feed side of the membrane.

Referring now to FIG. 2 there is shown a fresh water production well 20 which is equipped with a downhole aquifer water desalination system comprising an ESP 23 and an assembly of stacked tubular desalination membranes 22 and bypass tube 21. This configuration comprises an upstream ESP and downstream membrane assembly that are all run in-line with the production tubing 25, and cannot be retrieved by wireline. Saline aquifer water flows from the aquifer layer 24 through perforations 27 in the well casing 28, and is taken into the ESP 23 which pumps the aquifer water into the desalination membrane assembly 22. A secondary stream of concentrated reject brine flows through the bypass tube 21 alongside the ESP 23, and through a brine disposal tubing 26 which is equipped with a composition monitoring device 26a, into a brine disposal zone 29. Fresh water flows out the top of the assembly of desalination membranes 22, and through the production tubing 25 to surface. The data recorded by the downhole monitoring device will be transferred to surface by a signal and/or power transmission cable 30 shown in the drawing.

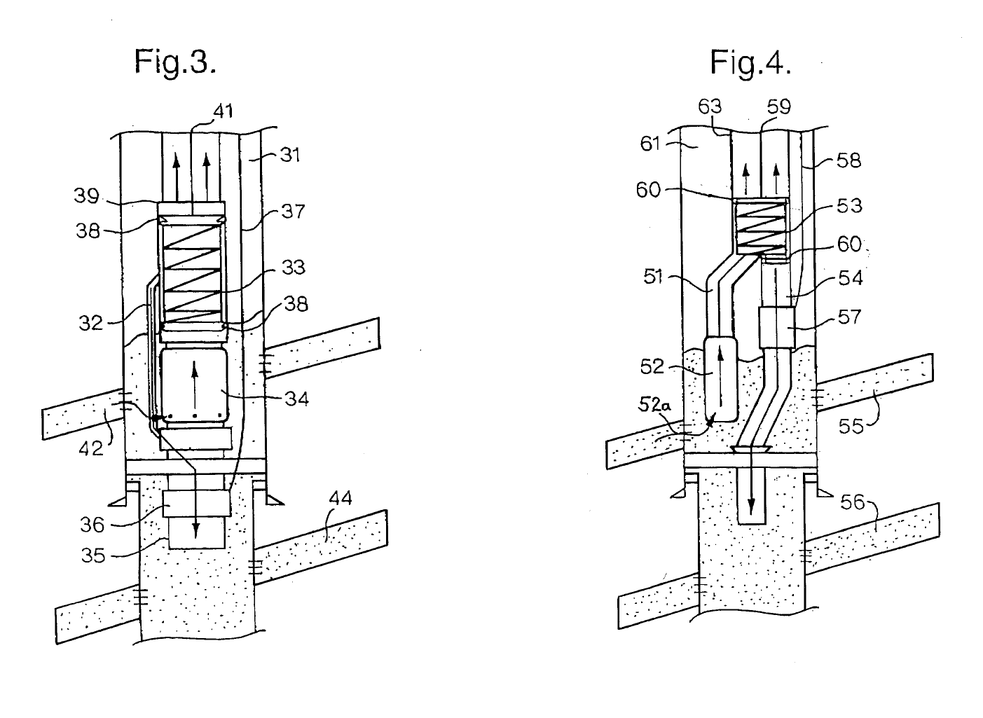

Referring to FIG. 3 there is shown fresh water production well 31 which is equipped with a partially wireline retrievable downhole desalination system of which solely the assembly of desalination membranes 33 is wireline retrievable, whereas the ESP 34 and brine by pass tube 32 are fixed to the lower end of the fresh water production tubing 39. The assembly of desalination membranes 33 is lowered into, and removable from, a recess at the lower end of the fresh water production tubing 39 by means of a wireline 41. Once at the correct depth, the plug 38 on the membrane assembly 33 are set. Flow of saline water into the well 31 from a saline aquifer layer 42 will be taken into the ESP 34, and forced up into the assembly of desalination membranes 33. The secondary stream of concentrated brine is put out the side of the membrane assembly 33, and due to the seals 38 in the annulus of the tubing 39 the secondary stream of concentrated reject brine is discharged from the annulus down into the bypass tube 32. From the bypass tube 32 it enters the brine discharge tubing 35 and flows into the disposal zone 44. The data recorded by a downhole monitoring device 36 in the brine discharge tubing 35 will be transferred to surface by a cable 37.

FIG. 4 shows yet another embodiment of a downhole desalination and/or purification system which comprises an ESP 52, an assembly of desalination membranes 53, and a downhole monitoring device 57. The desalination membrane assembly 53 is fully deployable on wireline 59. It will be lowered down, whereupon the plug seals 60 will be set, thus sealing off the different flow streams within the well 61 while outside of the assembly of desalination membranes 53. Flow enters from the aquifer layer 55, and is taken in through the intake of the ESP 52 as indicated with the arrow 52a. The aquifer water is then pumped by the ESP 52 into an aquifer water transmission conduit 51 into the inlet of the assembly of desalination membranes 53. A secondary concentrated brine stream leaves the desalination membrane assembly 53 at the retentate side and flows through a brine disposal conduit 54, down into a brine disposal zone 56 at the bottom of the well 61. The primary fresh water stream flows upward from the upper end of the membrane assembly 53 into a large diameter fresh water production tubing 63, which transports the purified fresh water to surface. The data recorded by the downhole monitoring device 57 are transferred to surface by an electrical or fibre optical signal transmission cable 58.

Electrical power required for operating the present invention, in particular for driving a downhole pump, can be generated by means of photovoltaic cells near the wellhead. This can be of particular advantage for application in locations remote from access to a power grid, such as desert areas. As a result, a single well with a minimum of surface installations can provide desalinated water and no waste streams.

We claim:

1. A method for desalinating saline aquifer water, the method comprising the steps of:
providing a well extending from the surface into a saline aquifer, the well comprising a downhole membrane effective to desalinate or purify the saline aquifer water;
allowing saline aquifer water to flow into the well from the saline aquifer;
separating the saline aquifer water into a primary desalinated water stream and a secondary concentrated brine reject stream; and
producing the primary desalinated water stream to the surface.

2. The method of claim 1, wherein the secondary brine reject stream is injected into a subsurface brine disposal zone.

2. The method of claim 1, wherein the downhole membrane assembly comprises one or more reverse osmosis membrane.

3. The method of claim 1, wherein the downhole membrane assembly comprises one or more nano-filtration membrane.

4. The method of claim 1, wherein the downhole membrane assembly comprises one or more non-porous hydrophilic membrane.

5. The method of claim 1, wherein the downhole membrane assembly comprises one or more semi-permeable membrane.

6. The method of claim 1 wherein the downhole membrane assembly comprises a plurality of stacked substantially tubular membrane modules.

7. The method of claim 1 wherein the primary desalinated water stream is pumped to surface by a pump.

8. The method of claim 7 wherein the pump is arranged downhole in the well.

9. The method according to claim 7, wherein the pump is arranged upstream of the membrane assembly.

10. The method of claim 7 wherein the pump and membrane assembly is built into a single unit which is retrievable from, and insertable into, a downhole receptor near an inflow region of the well, using a wireline hoisting system.

11. The method according to claim 7 wherein the pump is an electrical submersible pump.

12. The method according to claim 7 wherein the pump is a hydraulic pump.

13. The method of claim 1 wherein the composition of the aquifer water injected and/or purified fresh water produced to surface, flow rate of the primary aquifer water stream and/or secondary purified water streams, pressures and temperatures at different points downhole, flow rate to surface, are monitored with downhole monitoring devices, and the data are transmitted to surface via communication links.

14. The method of claim 13 wherein the communication link comprises an electric cable.

15. The method of claim 13 wherein the communication link comprises a fibre optical cable.

16. The method of claim 13 wherein the communication link comprises a wireless electromagnetic telemetry system.

17. The method of claim 13 wherein the communication link comprises an acoustic telemetry system.

18. A well for producing desalinated water from a subsurface aquifer layer to surface, which well comprises a downhole aquifer inflow region and a downhole assembly of one or more desalination and/or purification membranes effective for separating the saline aquifer water into a primary desalinated water stream and a secondary concentrated brine reject stream, and a conduit for transporting desalinated fresh water to surface.

19. The well according to claim 18, further comprising means for disposing concentrated brine into a subsurface disposal formation.

20. The well according to claim 18 wherein the downhole membrane assembly comprises one or more reverse osmosis membranes.

21. The well according to claim 18 wherein the downhole membrane assembly comprises one or more nano-filtration membranes.

22. The well according to claim 18 wherein the downhole membrane assembly comprises one or more non-porous hydrophilic membranes.

23. The well according to claim 18 wherein the downhole membrane assembly comprises one or more semi-permeable water desalination and/or purification membranes.

24. The well according to any one of claim 18 wherein the downhole membrane assembly comprises a plurality of stacked substantially tubular membrane modules.

24. The well according to claim 18 further comprising a downhole pump for generating the pressure needed for membrane separation.

25. The well according to claim 18 further comprising a downhole pump for pumping desalinated water to surface.

26. The well according to claim 18 further comprising a downhole pump for pumping concentrated brine into a disposal formation.

27. The well according to claim 24, wherein the downhole membrane assembly is arranged upstream of the pump.

28. A membrane assembly for use in a method according to claim 1, which membrane assembly is retrievable from, and insertable into, an aquifier well, and which membrane assembly comprises a plurality of stacked membrane modules.

29. A membrane assembly for use in a method according to any one of claims 1, and which membrane assembly is built into a single unit with a pump, which unit is retrievable from, and insertable into, a downhole receptor near the inflow region of the well, using a wireline hoisting system.
